(19) United States
(12) Patent Application Publication
(10) Pub. No.: US 2007/0010333 A1
(43) Pub. Date: Jan. 11, 2007

(54) Computer game development system and method

(75) Inventors: Chaucer Chiu, Taipei (TW); Gost Ye, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/286,517

(22) Filed: Nov. 22, 2005

(30) Foreign Application Priority Data
Jul. 5, 2005 (TW) 094122634

(51) Int. Cl. A63F 13/00

(52) U.S. Cl. 463/43

(57) ABSTRACT

A computer game development system and method are provided. The system includes an engine database for storing a plurality of function engines used for constructing a computer game, a setting module, a relating module and an integrating module. While a computer game is developed, corresponding function engines are invoked from the engine database according to a design demand of the computer game, corresponding attributes of the function engines are modified according to a management demand of the computer game, relationships between the function engines are edited to create a relating datasheet, and the function engines are integrated in accordance with the relating datasheet, so as to construct a basic structure of the computer game. The computer game has therefore a modularized structure. Accordingly, development processes for computer games are more flexible and costs of development and maintenance for computer games are also reduced effectively.

### BACKGROUND OF THE INVENTION

1. Field of the Invention

The present invention relates to computer game development systems and methods and, more particularly, to a computer game development system and method to develop computer game engines.

2. Description of Related Art

Nowadays computer games are becoming one of most important amusement for teenagers. A computer game which is designed perfectly can not only lead a user into a visional world which is ultra realistic, but also teach the user life values and knowledge different from that written on textbooks in the process or ending of the computer game. That is to say, a good computer game can make it joyful in education.

However a computer game engine is just like a racing engine. Contents of plots, toll-gates, art designs, sounds, operations and the like which players have experienced are directly controlled by the game engine, and the game engine which acts as a midfield engine binds all elements in the game to work simultaneously and orderly in the background. In simplicity, the engine is a main program used to control all game functions which include calculating collision, physical system and relative positions of objects; receiving inputs of players, and outputting sounds according to accurate volumes. Obviously, no matter 2D games or 3D games; no matter role play games, instant tactics games, risk and riddle games, or action and shooting games; and even a 1M small game all have such a section of codes with control functions.

The purpose of developing game engines is to shorten developing time. As the game engine has a few special effects and operating functions, the game developer may concentrate on game designs in place of these trivial and complicated elements, thereby the developing speed can be increased and the developing time can be shortened.

However, each game needs a set of corresponding game engines and each game engine may includes many mutual elements such as graphics, sounds, special effects, camera controls and the like. But a developer must compile the code from the beginning to describe these elements while developing a new game because each engine does not have commonality; this causes a great deal of rehandings such that the developing period and cost of the game is increased.

Additionally, the communications between programmers and art designers, map designers, layout operators are very important. In general, a more complicated scene means a more delicate display (including skeletal cartoon of persons, materials, surfaces of earth, building objects, maps and interfaces), correspondingly the more complicated scene means the game is less fluent. So how to get a balance between the fluency of the game and the delicacy of the display is an important key during the game development, thereby the communication and coordination between the programmers and the art designers, map designers are very important. However, the art designers and map designers can not understand the ideas of the programmers and the programmers also can not understood the hardness of scene fabricated by the art designers and map designers as the two teams are different in standpoint and knowledge background; this may cause mutual restraint of the two teams such that the fabricating time of the game is delayed and the development of the game becomes more difficult.

Therefore, how to develop a basic structure of game development design for drawing out mutual elements from all game engines and improve the communication between programmers and art designers, map designers are subjects to be solved by those in the art.

### SUMMARY OF THE INVENTION

To overcome the above-mentioned problems, it is a primary objective of the present invention to provide a computer game development system and method for modifying corresponding attributes of function engines to construct a computer game in accordance with demands and providing universality to the function engines.

It is another objective of the present invention to provide a computer game development system and method to increase flexibility of development processes for computer games.

It is a further objective of the present invention to provide a computer game development system and method to reduce costs of development and maintenance for computer games.

To achieve the above-mentioned and other objectives, a computer game development system and method are provided according to the present invention. The system includes an engine database for storing a plurality of function engines used for constructing a computer game, a setting module for invoking corresponding function engines from the engine database in accordance with a design demand of the computer game, a modifying module for modifying corresponding attributes of the function engines in accordance with a management demand of the computer game, a relating module for editing relationships between the function engines of the computer game so as to create a corresponding relating datasheet, and an integrating module for integrating the function engines to build a basic structure of the computer game according to the relating datasheet. The system further includes a plurality of editors for providing model data of the computer game to an editing interface to create a model database. The editors at least include an object editor, a terrain editor, an incident editor and an interface editor. The model data at least include a role model, an object model, a terrain model and an interface model of the computer game. The setting module further includes a capability of enabling the invoked function engines to select corresponding model data from the model database in accordance with the design demand of the computer game and to compile the model data with an edition function of the invoked function engines to create a corresponding basic unit. The function engines include a scene managing engine, an incident managing engine, an interface managing engine, a sound managing engine and a network managing engine.

The computer game development method is applied to a computer game development system having an engine database. The method includes invoking corresponding function engines from the engine database, modifying corresponding attributes of the function engines if the function engines do not conform to a management demand of the computer game, editing relationships between the function engines of the computer game to create a corresponding relating datasheet, and integrating the function engines to build a basic structure of the computer game according to the relating datasheet. The method further includes providing model data of the computer game to an editing interface to create a model database. The model data is edited by a plurality of editors. The editors at least include an object editor, a terrain editor, an incident editor and an interface editor. The model data at least include a role model, an object model, a terrain model and an interface model of the computer game. The method further includes selecting corresponding model data from the model database in accordance with the design demand of the computer game and compiling the model data with an editing function of the function engines, so as to create a corresponding basic unit. The function engines include a scene managing engine, an incident managing engine, an interface managing engine, a sound managing engine and a network managing engine.

The computer game development system and method of the present invention are proposed to substantially modularize the function engines of the computer game for modifying corresponding attributes of function engines in accordance with demands and providing universality to the function engines. Accordingly, computer game development processes are more flexible and costs of development and maintenance for computer games are also reduced effectively.

### BRIEF DESCRIPTIONS OF THE DRAWINGS

FIG. 1 is a functional block diagram of a computer game development system of the preferred embodiment according to the present invention;

FIG. 2A is a flow chart of a computer game development method corresponding to the computer game development system shown in FIG. 1 according to the present invention; and

FIG. 2B is an explanatory view showing a preferred embodiment of the FIG. 2A.

### DETAILED DESCRIPTIONS OF PREFERRED EMBODIMENTS

The following special embodiment is provided to illustrate the disclosure of the present invention, these and other advantages and effects can be apparently understood by those in the art after reading the disclosure of this specification. The present invention can also be performed or applied by other different embodiments. The details of the specification may be on the basis of different points and applications, and numerous modifications and variations can be devised without departing from the spirit of the present invention.

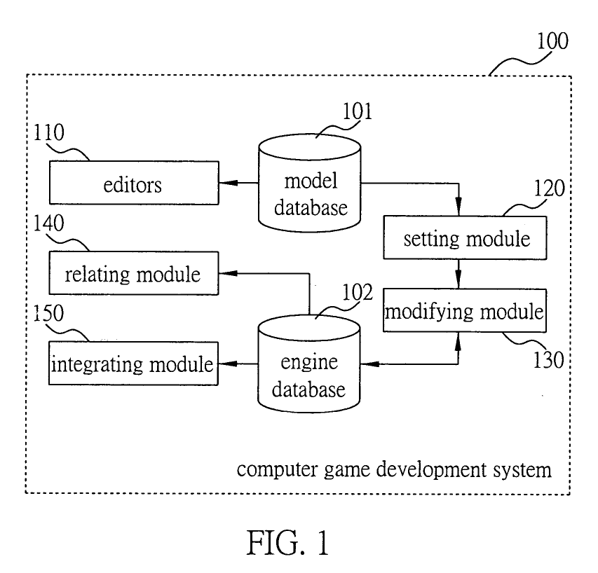

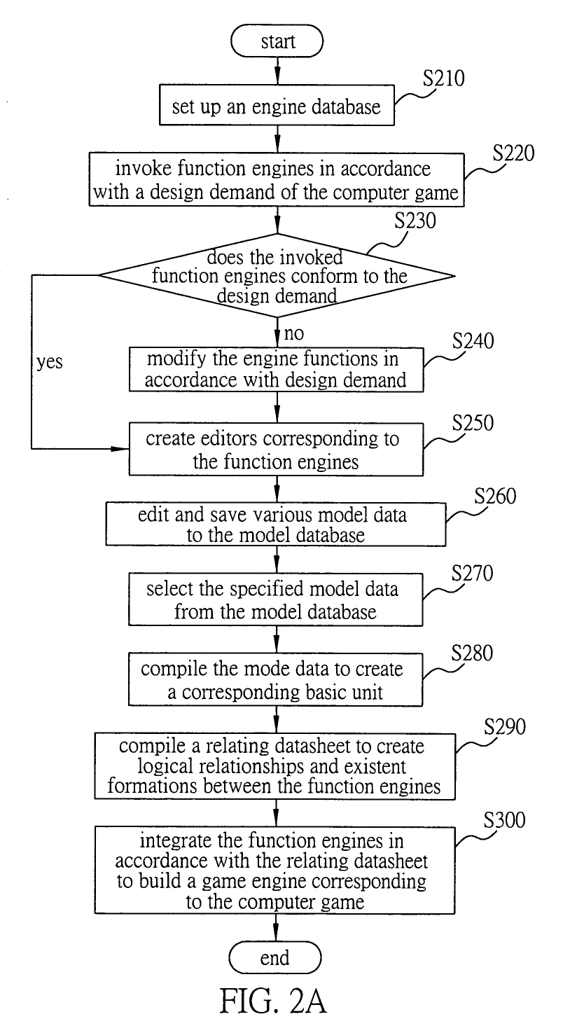

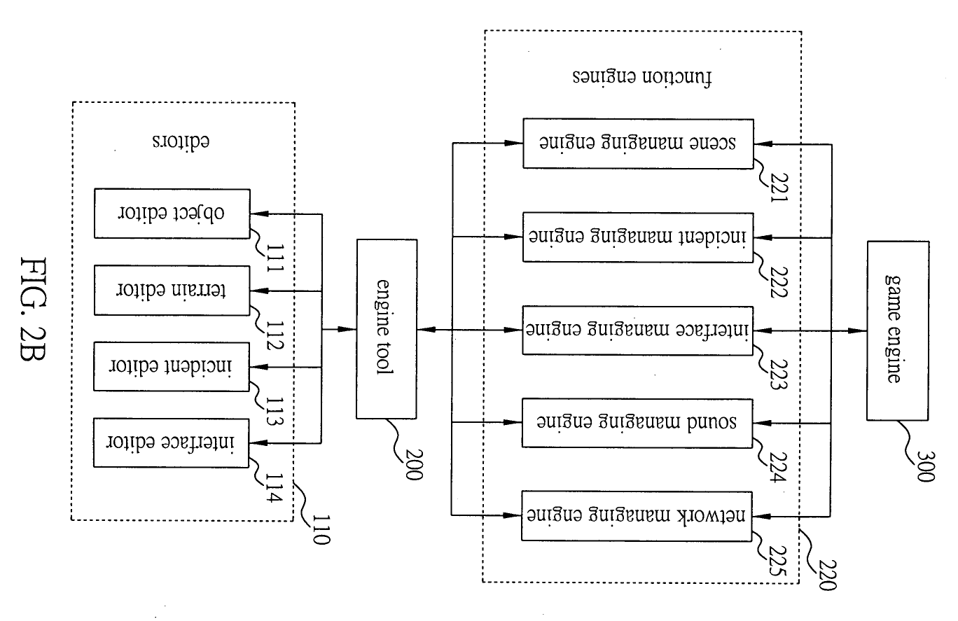

Please refer to FIG. 1, which is a functional block diagram of a computer game development system 100 of the preferred embodiment according to the present invention. The computer game development system 100 is used in a computer (not shown in FIG. 1). The computer game development system 100 comprises a model database 101, an engine database 102, a plurality of editors 110, a setting module 120, a modifying module 130, a relating module 140 and an integrating module 150. The model database 101 is used to store various model data in a computer game, and the engine database 102 is used to store various function engines 220 including a scene managing engine 221, an incident managing engine 222, an interface managing engine 223, a sound managing engine 224 and a network managing engine 225, all of which are used for constructing the computer game (as shown in FIG. 2B).

The editors 110 are used to provide an editing interface to a user for editing various model data of the computer game in accordance with a design demand of the game, such as roles, objects, terrain, incidents and operating interfaces of the game, and save the edited model data to a database in order to create a model database 101. Referring to FIG. 2B, different model data are edited by different editors 110. For example, an object editor 111 is used to edit objects changing constantly such as person, animal, automobile and the like, a terrain editor 112 is used to edit terrain, for example landscape, forest, ocean and other objects which do not change or change hardly in the computer game, an incident editor 113 is used to edit the plot evolution including a plurality of incidents of the game, and an interface editor 114 is used to edit graphical user interfaces (GUI). It should be noted that the editors 110 are generally decided by the types of the function engines which are used to construct the computer game.

The setting module 120 is used to invoke corresponding function engines 220 from the engine database 102 in accordance with the design demand of the computer game, and further to select corresponding model data from the model database 101 in accordance with the design demand of the computer game and compile the model data with an editing function of the function engines 220, so as to create a corresponding basic unit, which is a function managing subsystem of the computer game. In the present invention, the basic unit is one selected from a group consisting of a scene managing unit, an incident managing unit, an interface managing unit, a sound managing unit and so on.

The modifying module 130 is used to modify corresponding attributes of the function engines 220 in accordance with a management and development demand of the computer game.

The relating module 140 is used to editing relationships between the function engines of the computer game to create a corresponding relating datasheet. The relationships comprise logical relationships and existent formations of the function engines 220.

The integrating module 150 is used to integrate the function engines 220 and build a basic structure of the computer game according to the relating datasheet.

FIG. 2A is a flow chart of a computer game development method corresponding to the computer game development system 100 shown in FIG. 1 according to the present invention. In step S210, the engine database 102 is set up, and various function engines such as a scene managing engine, an incident managing engine, an interface managing engine, a sound managing engine, a network managing engine, a rule managing engine, 10 managing engine and the like are saved in the engine database 102. Then go to step S220.

In step S220, corresponding function engines 220 are invoked by the engine database 102 in accordance with the design demand of the computer game. In the present embodiment, the scene managing engine 221, the incident managing engine 222, the interface managing engine 223, the sound managing engine 224 and the network managing engine 225 are all invoked from the engine database 102 in accordance with the design demand of the computer game (as shown in FIG. 2B). Then go to step S230.

In step S230, whether the function engines are conformed to the design demand of the computer game is judged. Go to step S250 if the answer is yes, otherwise go to step S240.

In step 240, corresponding attributes of the function engines 220 are modified in accordance with the design demand of the computer game. Then go to step S250.

In step S250, editors 110 corresponding to the function engines 220 are created by an engine tool 200. In this embodiment, the object editor 111 and the terrain editor 112 are made by the scene managing engine 221, the incident editor 113 is made by the incident managing engine 222, and the interface editor 114 is made by the interface managing engine 223. Go to step S260.

In step S260, various model data are edited by the editors 110 and saved to the model database 101. In this embodiment, object data such as persons, animals and automobiles are edited by the object editor 111, terrain data such as oceans and lands are edited by the terrain editor 112, incidents of the game are edited by the incident editor 113, and graphical user interfaces are edited by the interface editor 114. Then go to step S270.

In step S270, the specified model data are selected from the model database 101 by the function engines 220. Then go to step S280.

In step S280, the model data are compiled by the function engine 220 to create a corresponding basic unit, which is a managing subsystem of each function. Then go to step S290.

In step S290, a relating datasheet is compiled to create logical relationships and existent formations between the function engines. Then go to step S300.

In step S300, the function engines 220 are integrated in accordance with the relating datasheet to build a game engine 300 corresponding to the computer game.

As a result, the computer game development system and method of the present invention which can be used in developing a plurality of computer games substantially modularizes the function engines of the computer games for modifying corresponding attributes of function engines in accordance with practical design demands and providing universality to the function engines. Accordingly, development processes for computer games are more flexible and costs of development and maintenance for computer games are also reduced effectively.

The foregoing descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

What is claimed is:

1. A computer game development system comprising:
an engine database for storing a plurality of function engines for constructing a computer game;
a setting module for invoking corresponding function engines from the engine database in accordance with a design demand of the computer game;
a modifying module for modifying corresponding attributes of the function engines in accordance with a management demand of the computer game;
a relating module for editing relationships between the function engines for the computer game so as to create a corresponding relating datasheet; and
an integrating module for integrating the function engines to build a basic structure of the computer game according to the relating datasheet.

2. The computer game development system of claim 1, further comprising a plurality of editors for providing model data required by the computer game to an editing interface to create a model database.

3. The computer game development system of claim 2, wherein the editors comprise an object editor, a terrain editor, an incident editor and an interface editor.

4. The computer game development system of claim 3, wherein the model data comprise data of a role model, an object model, a terrain model, an incident model and an interface model of the computer game.

5. The computer game development system of claim 2, wherein the setting module is further capable of enabling the invoked function engines to select corresponding model data from the model database in accordance with the design demand of the computer game and to compile the selected model data with an editing function of the invoked function engines to create a corresponding basic unit.

6. The computer game development system of claim 1, wherein the function engines comprise a scene managing engine, an incident managing engine, an interface managing engine and a sound managing engine.

7. The computer game development system of claim 1, wherein the function engines comprise a network managing engine.

8. The computer game development system of claim 5, wherein the basic unit is a function managing subsystem of the computer game.

9. The computer game development system of claim 8, wherein the basic unit is one selected from the group consisting of a scene managing unit, an incident managing unit, an interface managing unit and a sound managing unit.

10. The computer game development system of claim 1, which is applied in a computer.

11. A computer game development method applied to a computer game development system having an engine database, the computer game development system comprising the steps of:
(1) invoking corresponding function engines from the engine database in accordance with a design demand of a computer game;
(2) modifying corresponding attributes of the function engines if the function engines do not correspond to a management demand of the computer game;
(3) editing relationships between the function engines for the computer game so as to create a corresponding relating datasheet; and
(4) integrating the function engines to build a basic structure of the computer game according to the relating datasheet.

12. The computer game development method of claim 11, further comprising providing model data required by the computer game to an editing interface to create a model database.

13. The computer game development method of claim 12, wherein the model data are edited by a plurality of editors.

14. The computer game development method of claim 13, wherein the editors comprise an object editor, a terrain editor, an incident editor and an interface editor.

15. The computer game development method of claim 12, wherein the model data comprise data of a role model, an object model, a terrain model, an incident model and an interface model of the computer game.

16. The computer game development method of claim 12, further comprising selecting corresponding model data from the model database in accordance with the design demand of the computer game and compiling the model data with an editing function of the invoked function engines to create a corresponding basic unit.

17. The computer game development method of claim 11, wherein the function engines comprise a scene managing engine, an incident managing engine, an interface managing engine and a sound managing engine.

18. The computer game development method of claim 11, wherein the function engines comprise a network managing engine.

19. The computer game development method of claim 16, wherein the basic unit is a function managing subsystem of the computer game.

20. The computer game development method of claim 19, wherein the basic unit is one selected from the group consisting of a scene managing unit, an incident managing unit, an interface managing unit and a sound managing unit.
